(19) United States
(12) Patent Application Publication
(10) Pub. No.: US 2026/0290036 A1
(43) Pub. Date: Sep. 24, 2026

(54) METHOD FOR DETERMINING THE CURVE PROGRESSION OF CURVES NOT CLOSED IN THEMSELVES

(71) Applicants: CARIAD SE, Wolfsburg (DE); ROBERT BOSCH GMBH, Stuttgart (DE)

(72) Inventors: Daniel Bauer, Wolfsburg (DE); Christian Witte, Wolfsburg (DE); Hauke Brunken, Wolfsburg (DE); Joel Janai, Stuttgart (DE)

(73) Assignees: CARIAD SE, Wolfsburg (DE); ROBERT BOSCH GMBH, Stuttgart (DE)

(21) Appl. No.: 19/573,966

(22) Filed: Mar. 20, 2026

(30) Foreign Application Priority Data
Mar. 21, 2025 (DE) 10 2025 110 948.6

(51) Int. Cl. G06V 20/56; G06V 10/44; G06V 10/82; G06V 20/58; G06V 10/764

(52) U.S. Cl. CPC G06V 20/588; G06V 10/44; G06V 10/82; G06V 20/58; G06V 10/764

(57) ABSTRACT

A method for determining the curve progression of curves not closed in themselves. that the method includes associating at least one curve segment with a plurality of curves depending on the curve progression thereof. A two-dimensional raster image of raster cells is detected in a capturing range by an optical sensor system, from which raster cells associated with an image foreground of the raster image are ascertained as reference cells. From a set of the reference cells, active reference cells are selected, by the processing of which a start point and an end point are associated with a respective curve segment of a curve. At least one intermediate point is ascertained as a supporting point for a curve segment. Based on the start point, the end point and the intermediate point, a curve segment is represented as a B-spline representation.

### CROSS REFERENCE TO RELATED APPLICATIONS

This application is a based upon and claims the priority benefit of German Application No. 10 2025 110 948.6 filed on March 21, 2025, the entire contents of which are incorporated by reference herein.

### BACKGROUND

### 1. Field

An aspect of the invention relates to a method for determining the curve progression of curves not closed in themselves in a capturing range detected by an optical sensor system.

For certain purposes of application, it is required or desirable to determine a curve progression of a curve not closed in itself contained in a capturing range detected by an optical sensor system based on the image representation of the optical sensor system. In controlling vehicle tasks of vehicles during the drive of the vehicle, the progression of roadway lines in the traffic space around the vehicle for example often has to be determined from the image representation of an optical sensor system of the vehicle.

This is in particular relevant in assistance systems employed in vehicles for controlling the driving operation of the vehicle and thereby for assisting or relieving the driver of the vehicle in certain driving situations or in certain movement operations of the vehicle, since these

### SUMMARY

An aspect of the invention is based on the object to specify a method for determining the curve progression of curves not closed in themselves, in which an extraction of the curve progression of these curves from the sensor data of an optical sensor system is allowed with high reliability in simple and advantageous manner.

According to an aspect of the invention, this object is solved by a method for determining the curve progression of curves not closed in themselves with the features recited in claim 1.

Advantageous developments of the method according to the invention are a constituent of the further claims.

In the method according to an aspect of the invention for determining the curve progression of curves not closed in themselves in a capturing range detected by an optical sensor system, in a preliminary scenario, for a plurality of possible curve progressions of curves not closed in themselves, at least one curve segment is first associated with a curve respectively considered there depending on the curve progression thereof. This means, within the scope of a preselection, a corresponding number of curve segments is respectively associated with a plurality of curves not closed in themselves and thereby also with the curves not closed in themselves possibly occurring in the capturing range based on the curve progressions thereof, such that a respective curve not closed in itself is divided into a certain number of curve segments depending on its respective curve progression. Whether a division of a certain curve not closed in itself into curve segments is then required in the capturing range, is set based on certain previously defined criteria and properties of the respective curve progressions of curves not closed in themselves. For example, an artificial neural network, ANN, can be used for this setting, to which a plurality of different curve progressions of curves not closed in themselves is supplied for processing.

With the background knowledge of this preliminary scenario, a two-dimensional raster image of raster cells is detected by the optical sensor system in the capturing range. The raster cells detected by the optical sensor system as optical sensor data as image elements or pixels first include pure color values (RGB values) and a coordinate specification as a respective index value for localizing the respective raster cells as information.

Preferably, these color values of the raster cells are then transformed into an information range with information values by a processing unit, for example by a neural network, such that a certain information content is respectively associated with the raster cells after this transformation. Thus, the respective raster cells are characterized by their coordinates as respective index values and by their information content after this transformation.

Thereupon, from the entirety of the raster cells of the two-dimensional raster image, the raster cells associated with the image foreground of the raster image are ascertained as reference cells. Hereto, the optically detected two-dimensional raster image is divided into semantic parts, in particular with respect to the property of image foreground of the raster image and with respect to the property of image background of the raster image. This means, a semantic classification of the entirety of the raster cells with respect to the property class of image foreground of the raster image on the one hand and the property class of image background of the raster image on the other hand is effected. Based on this classification task, in particular with respect to the properties of color black equal to zero equal to image background on the one hand and the color white equal to one equal to image foreground on the other hand, the raster cells are associated with the respective property class based on their respective information content. The raster cells associated with the image foreground of the raster image as the foreground cells and thereby as the reference cells are in turn characterized by their coordinates as the respective index values and by a certain information content.

In an advantageous configuration of the method, the two-dimensional raster image of raster cells in the capturing range is transformed into a bird view for ascertaining the reference cells as the raster cells associated with the image foreground of the raster image. This means, the raster image with the raster cells is represented in a bird view for ascertaining the reference cells.

Furthermore, a certain number of active reference cells is selected from the set of the thus ascertained reference cells associated with the image foreground of the raster image. This object selection of the active reference cells from the reference cells associated with the image foreground of the raster image is in particular effected based on a plurality of search queries to the reference cells with respect to the properties thereof and thereby with respect to the information content thereof. As a result of these search queries, individual active reference cells are output, whereby the further processing of the method according to the invention is significantly simplified due to the only low number of reference cells to be considered instead of a plurality of reference cells to be used otherwise. The active reference cells ascertained hereby are also characterized by their coordinates as respective index values and by their information content.

In an advantageous configuration of the method, this selection of the individual active reference cells from the set of the reference cells associated with the image foreground is effected by means of an object detector, for example a so-called detection transformer (DETR).

In a further advantageous configuration of the method, before the selection of the active reference cells, a selection set of selected reference cells is first ascertained from the set of the reference cells by means of a probability assessment. These selected reference cells are then used for the selection of the active reference cells. This means, from the set of the raster cells associated with the image foreground of the raster image having a certain number of elements, a selection set or subset with a lower number of raster cells is generated as the selected reference cells based on a probability assessment. Hereto, for each raster cell, a probability value for the association thereof with a curve structure and thereby with the image foreground is determined within the scope of object recognition. Based on these probability values, those raster cells with the greatest probability value are ascertained as the selected reference cells. In particular, for this object recognition with respect to the raster cells and thereby for ascertaining the selection set of selected reference cells from the set of the reference cells, the method of non-maximum suppression (NMS) is applied. The selected reference cells hereby chosen from the raster cells and from the set of the reference cells are also characterized by their coordinates as the respective index values and by their information content.

Based on a processing of the ascertained active reference cells, two control points of a curve segment are associated with the respective curve segment of a curve closed in itself in the capturing range, namely a start point of the curve segment as a first control point and an end point of the curve segment as a second control point.

In an advantageous configuration of the method, a prediction of the control points of a respective curve segment and thereby of the start point of a respective curve segment and of the end point of a respective curve segment is continuously effected via a regression by means of distance vectors and thereby via the determination of offset values between a respective active reference cell and a predicted control point. This means, based on the set of the active reference cells, the two control points are predicted as the start point of the curve segment and as the end point of the curve segment. Hereto, the inherent properties of the active reference cells are used, from which the respective offset of a respective active reference cell with respect to a respectively predicted control point as the end point of a respective curve segment and as a start point of a respective curve segment is then determined. Hereby, it is in particular ascertained, which ones of the active reference cells are closest to one of the two control points. Thus, the control points are overall ascertained based on the active reference cells and a respective offset value for these active reference cells.

If the curve segment of a curve not closed in itself extends across the entire capturing range, the two control points of this curve segment are at the respective end of the capturing range. If a curve segment in the capturing range does not extend across the entire capturing range, but extends only to its visible end, the end point of the curve segment represents the end of the concerned curve not closed in itself at the same time. At least two curve segments with respectively a start point and an end point are respectively associated with certain curve progressions of a curve not closed in itself in the capturing range, wherein the individual curve segments are then joined to each other to the overall progression of the curve not closed in itself in the capturing range. In curve segments thus joined to each other, the end point of a preceding curve segment is then the start point of the following curve segment at the same time.

A classification of the control points of a respective curve segment is effected, as described, by communication of the active raster cells with each other and by evaluation of the information content of the active raster cells. The start point of a respective curve segment and the end point of a respective curve segment are then ascertained based on the two control points determined using the active reference cells preferably by means of predecessor-successor evaluation of the active reference cells. The start point of a curve segment is then associated with that active reference cell, for which a predecessor has not been ascertained, the end point of a curve segment is then associated with that active reference cell, for which a successor has not been ascertained. This means, from this, a determination of the direction of a respective curve segment and an indication as to where a respective curve segment starts and where a respective curve segment stops or ends is effected.

Based on the two control points determined for a curve segment, at least one intermediate point is ascertained as a supporting point. This means, for each curve segment, a prediction of at least one intermediate point is effected, which is used for the representation of the respective curve segment of the curve not closed in itself and the curve progression thereof. In order to predict the at least one intermediate point, the information content of the active reference cells and thereby of the two associated control points and the raster cells surrounding them is used.

For ascertaining the at least one intermediate point as the supporting point, two matrices are preferably applied to the active reference cells. In particular, by application of a forward matrix and a backward matrix to the active reference cell, for each active reference cell, the successor and predecessor thereof is ascertained. Hereby, it is then ensured that the two control points of a respective curve segment as the start point of the respective curve segment and as the end point of the respective curve segment are indeed associated with each other.

If multiple supporting points are associated with a curve segment due to the curve progression thereof, a weighted average for the intermediate point then further used is formed from these supporting points.

Based on the two control points and the intermediate point, a respective curve segment is represented in the form of a B-spline. This means, the representation of a curve defined by specification of three points by means of the B-spline representation is employed for the representation of a respective curve segment. This B-spline representation used with knowledge of the two control points and the intermediate point as the supporting point for creating the respective curve segment only has a low sensitivity with possible deviations of the points defining it and therefore can be advantageously applied also in case of severely curved curve progressions.

Finally, the curve progression of a curve not closed in itself in the capturing range is composed of the associated curve segments and thereby of the B-spline representation of the respective curve segments.

If a curve not closed in itself in the capturing range has not been divided into multiple curve segments, the B-spline representation of the single curve segment thereby also corresponds to the representation of the overall curve not closed in itself in the capturing range.

In contrast, if a curve not closed in itself in the capturing range has been divided into multiple curve segments with respective B-spline representation, these thus represented curve segments are then joined to each other and composed for representing the overall curve not closed in itself in the capturing range.

In an advantageous development of the invention, the method according to the invention is used for determining the line progression of roadway lines in the traffic space around a vehicle during the drive of the vehicle. Hereto, optical sensor data and thereby two-dimensional raster images of raster cells are detected by an optical sensor system arranged in a vehicle in a capturing range in the traffic space around the vehicle.

Based on the raster cells of the two-dimensional raster image, the line progression of roadway lines in the capturing range around the vehicle is then in particular predicted. This means, a determination of the line progression of the roadway lines in the capturing range around the vehicle is performed in the capturing range in the traffic space around the vehicle based on the line probability for roadway lines. Hereto, areas are identified based on this probability assessment, in which roadway lines could be situated, based on a semantic segmentation in the capturing range in the traffic space around the vehicle.

Similarly, the method according to the invention can be used in the medical area for determining line structures, for example for determining the contours of tumors in the body of living beings, or in the manufacturing industry for recognizing cracks in components during the production of the components or in the remote sensing for determining roads or paths in satellite images.

Upon the application of the method according to the invention in the automotive sector, the orientation of trailers coupled to a towing vehicle can also be determined besides the mentioned determination of the line progression of roadway lines, as well as the driving planning for an autonomous driving operation of a vehicle or an automated driving operation of a vehicle can be assisted.

In particular, such a vehicle can be formed as a motor vehicle or automobile, as a passenger car or as a truck or as a motorcycle or as a passenger bus.

For controlling the method according to an aspect of the invention and the operations of the method according to an aspect of the invention and thereby for controlling the method sequence, a control device or a control module can be provided, by which the control of the optical sensor system and the neural network for processing and evaluating the optical sensor data and thereby the raster cells of the raster image is performed.

This control module or control device with at least one neural network and an optical sensor system and/or a control unit and/or an evaluation unit can in particular also be arranged in a vehicle. The mentioned components of the control module or control device can be configured as separate components and for example be arranged networked in a vehicle hereto. Alternatively hereto, individual or all components of the control module or control device can also be arranged modularly combined in a common component in a vehicle.

The invention also includes the combinations of the features of the described embodiments. Thus, the invention also includes realizations, which each comprise a combination of the features of multiple of the described embodiments if the embodiments have not been described as mutually exclusive.

With the method according to an aspect of the invention, curve progressions of curves not closed in themselves can be reliably extracted from the sensor data of an optical sensor system with high reliability in simple and advantageous manner and with low effort.

### BRIEF DESCRIPTION OF THE DRAWINGS

Exemplary embodiments of the invention are described hereunder. These and other aspects and advantages will become more apparent and more readily appreciated from the following description of the exemplary embodiments, taken in conjunction with the accompanying drawings of which:

In the following, an embodiment of the invention is described. Hereto, there shows:

FIG. 1 the schematic view of a flow diagram for the method according to an embodiment of the invention.

FIGS. 2a to 2c illustrate a detailed representation for explaining certain operations in the method sequence according to an embodiment of the invention.

FIGS. 3a, 3b to 3c illustrate a further detailed representation for explaining certain operations in the method sequence of the method according to an embodiment of the invention.

### DETAILED DESCRIPTION

Reference will now be made in detail to the preferred embodiments, examples of which are illustrated in the accompanying drawings, wherein like reference numerals refer to like elements throughout.

The embodiment explained in the following is a preferred embodiment of the invention. In the embodiment, the described components each represent individual features of the invention to be considered independently of each other, which also each develop the invention independently of each other and thereby are also to be regarded as a constituent of the invention in individual manner or in a combination different from the shown one. Furthermore, the described embodiment can also be supplemented by further ones of the already described features of the invention.

In the figures, functionally identical elements are each provided with the same reference characters.

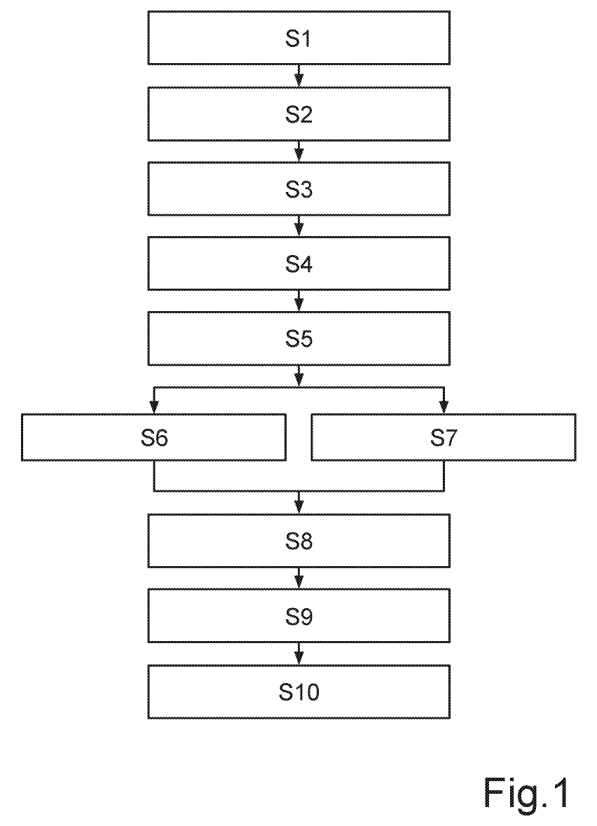

According to FIG. 1 (FIG. 1), it can be seen that in the method sequence of the method according to the invention, for determining the curve progression of curves not closed in themselves in a capturing range detected by an optical sensor system, the method operations S1 to S10 are executed for example for determining the curve progression of roadway lines in the traffic space around a vehicle during the drive of the vehicle.

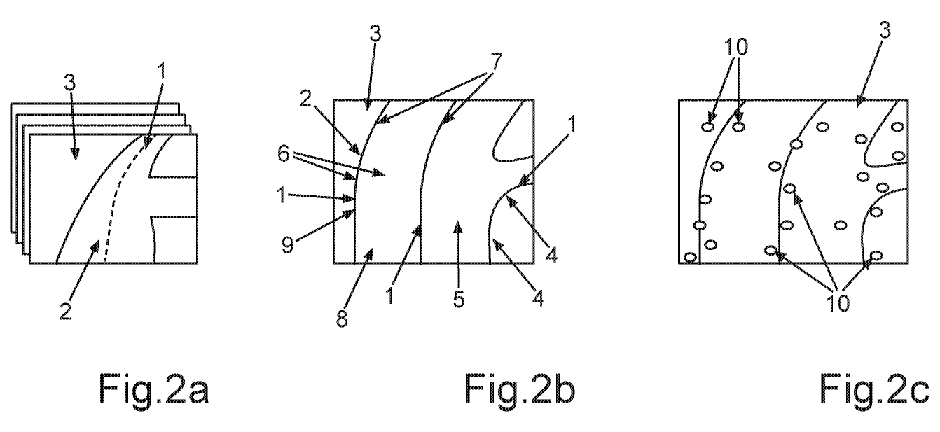

Hereto, the processed two-dimensional raster images 5 detected in the capturing range 3 are demonstrated during various operations in the FIGS. 2(2a, 2b) and 3 (3a, 3b, 3c).

In a first operation S1, for preparation in a training phase before drive of the vehicle, by an evaluation unit of the control module, for example by a neural network of the control module, a plurality of curves not closed in themselves is processed based on the curve progressions thereof to the effect if these curves not closed in themselves can be represented and processed without segmentation and thereby with a single curve segment, or if a segmentation into different curve segments adjoining to each other is required for these curves not closed in themselves and therefore a representation and processing of multiple curve segments is required hereto. As is for example apparent based on FIG. 2b, the curve 1 not closed in itself illustrated on the left in FIG. 2b and the curve 1 not closed in itself illustrated in the center in FIG. 2b do not have to be divided into multiple curve segments, such that the curve progression 2 of these two curves 1 respectively has only one single curve segment. In contrast, the curves 1 illustrated on the right in FIG. 2b have to be divided into two curve segments 4 in particular due to the severe curvature of their respective curve progression 2, such that the curve progression 2 of these two curves 1 respectively comprises two curve segments 4 joined to each other.

With the association of curves 1 not closed in themselves with curve segments 4 or the curve progressions 2 thereof in curves 1 not closed in themselves with curve segments 4, trained in the training phase, in operation S2, see also FIG. 2a and FIG. 2b hereto, optical sensor data is generated as two-dimensional raster images 5 of raster cells 6 or image elements or pixels by an optical sensor system of a vehicle in a capturing range 3 in the traffic space around the vehicle during the drive of the vehicle.

This optical sensor data of the raster cells 6 or image elements or pixels present as color values or RGB values is transformed into an information range with information values or into a property space with property values in operation S3. Hereby, at least one characteristic information or property is also associated with each raster cell 6 besides the index value localizing its position in the capturing range 3.

For example after a transformation of the two-dimensional raster image 5 of raster cells 6 or image elements or pixels into the bird view, in operation S4, see also FIG. 2b hereto, a classification of the raster cells 6 to the image foreground 7 or to the image background 8 is performed in this bird view. This classification of the raster cells 6 to the image foreground 7 or to the image background 8 is effected based on a digital association of the raster cells 6 either with the color black and thereby as associated with the image background 8 or with the color white and thereby as associated with the image foreground 7 and thereby with a potential roadway line as a curve 1 not closed in itself. The raster cells 6 hereby associated with the image foreground 7 are further processed as reference cells 9.

In operation S5, see also FIG. 2c hereto, a subset of selected reference cells 10 is selected from the set of the reference cells 9. Hereto, the method of non-maximum suppression is applied to the set of the reference cells 9, whereby only those reference cells 9 are selected from the set of the reference cells 9 as the selected reference cells 10, which have the greatest probability with respect to the association with the image foreground 7. Since the subset of the selected reference cells 10 has a significantly lower number of elements than the set of the reference cells 9, the method sequence of the method according to the invention is substantially accelerated hereby.

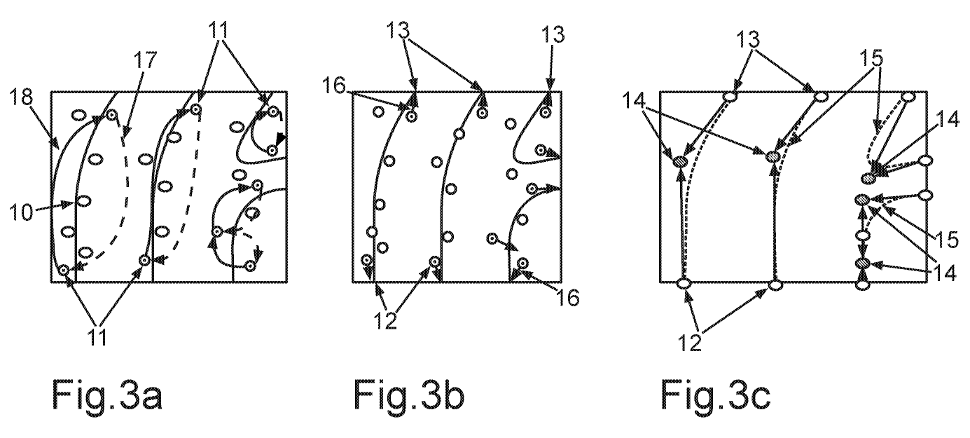

In operation S6 and method step S7, see also FIG. 3a and FIG. 3b hereto, a predecessor-successor determination is performed based on these selected reference cells 10, this means, for each selected reference cell 10, the successor 18 thereof and the predecessor 17 thereof are determined. Hereby, a selection of active reference cells 11 is performed, which are at the end of the curve progression 2 of a roadway line as a curve 1 not closed in itself and/or at the end of a curve segment 4 of the curve progression 2 of a roadway line as a curve 1 not closed in itself and/or are at the end of the capturing range 3 with high probability, and a prediction of the closest curve end of a roadway line as a curve 1 not closed in itself is performed. For determining the curve end, control points 12, 13 as a start point 12 and as an end point 13 of a roadway line as a curve 1 not closed in itself or of a curve segment 4 of this roadway line as a curve 1 not closed in itself are ascertained. Hereto, the distance vector 16 between the active reference cells 11 and a predicted respective control point 12, 13 as the start point 12 and the end point 13 of a roadway line as a curve 1 not closed in itself or of a curve segment 4 of this roadway line as a curve 1 not closed in itself is used.

In operation S8, see also FIG. 3c hereto, a prediction of at least one intermediate point 14 is performed based on the two control points 12, 13 as the start point 12 and the end point 13 of a roadway line as a curve 1 not closed in itself or of a curve segment 4 of this roadway line as a curve 1 not closed in itself.

In operation S9, see also FIG. 3c hereto, a B-spline representation 15 of the respective roadway line as a curve 1 not closed in itself or of a curve segment 4 of this roadway line as a curve 1 not closed in itself is performed using the two control points 12, 13 as the start point 12 and the end point 13 of a roadway line as a curve 1 not closed in itself or of a curve segment 4 of this roadway line as a curve 1 not closed in itself as well as the at least one associated intermediate point 14 as a supporting point.

If at least two curve segments 4 are associated with a curve progression 2 of a roadway line as a curve 1 not closed in itself, such as for example the curve 1 illustrated on the right in FIG. 2b, the individual curve segments 4 represented by means of the B-spline representation 15 are joined to each other for overall representation of the respective roadway line as a curve 1 not closed in itself.

Thus, the example overall shows, how a determination of roadway lines from the raster images ascertained by an optical sensor system of a vehicle can be advantageously performed during the drive of the vehicle in a capturing range in the traffic space around the vehicle.

### LIST OF REFERENCE CHARACTERS

1 Curves

2 curve progression

3 capturing range

4 curve segment

5 two-dimensional raster image

6 raster cells

7 image foreground

8 image background

9 reference cells

10 selected reference cells

11 active reference cells

12 control point as a start point

13 control point as an end point

14 intermediate point as a supporting point

15 B-spline representation

16 distance vector

17 predecessor

18 successor

A description has been provided with particular reference to preferred embodiments thereof and examples, but it will be understood that variations and modifications can be effected within the spirit and scope of the claims which may include the phrase "at least one of A, B and C" as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method of determining curve progression of curves in a capturing range detected by an optical sensor system, comprising:
associating, for a plurality of possible curve progressions of the curves not closed in themselves, at least one curve segment with a respective curve not closed in itself depending on the curve progression thereof,
detecting, by the optical sensor system in the capturing range, a two-dimensional raster image of raster cells, of which raster cells associated with an image foreground of the two-dimensional raster image are ascertained as reference cells,
selecting active reference cells of a certain number from a set of the reference cells,
by processing the active reference cells, two control points as a start point and as an end point of the at least one curve segment are associated with the at least one curve segment of the respective curve,
ascertaining at least one intermediate point as a supporting point for the two control points of the at least one curve segment,
representing the at least one curve segment as a B-spline representation based on the two control points and the at least one intermediate point,
wherein a curve progression the respective curve in the capturing range is composed of the B-spline representation of associated curve segments.

2. The method according to claim 1, wherein
for ascertaining the two control points of the at least one curve segment, an evaluation of a respective distance vector between the active reference cells and predicted control points is used.

3. The method according to claim 1, wherein
the start point of the at least one curve segment and the end point of the at least one curve segment are determined based on a predecessor-successor evaluation of the active reference cells.

4. The method according to claim 2, wherein
the start point of the at least one curve segment and the end point of the at least one curve segment are determined based on a predecessor-successor evaluation of the active reference cells.

5. The method according to claim 1, wherein
a selection set of selected reference cells is ascertained from the set of the raster cells or the set of the reference cells by a probability assessment and the selected reference cells are used for the selecting of the active reference cells.

6. The method according to claim 2, wherein
a selection set of selected reference cells is ascertained from the set of the raster cells or the set of the reference cells by a probability assessment and the selected reference cells are used for the selecting of the active reference cells.

7. The method according to claim 1, wherein
the two-dimensional raster image of the raster cells in the capturing range is transformed into a bird view.

8. The method according to claim 2, wherein
the two-dimensional raster image of the raster cells in the capturing range is transformed into a bird view.

9. The method according to claim 5, wherein
the selecting of the active reference cells from the set of the raster cells or the selected reference cells is effected by an object detector.

10. The method according to claim 6, wherein
the selecting of the active reference cells from the set of the raster cells or the selected reference cells is effected by an object detector.

11. The method according to claim 1, wherein
the at least one intermediate point of the at least one curve segment is ascertained based on a predecessor-successor evaluation for each active reference cell.

12. The method according to claim 2, wherein
the at least one intermediate point of the at least one curve segment is ascertained based on a predecessor-successor evaluation for each active reference cell.

13. The method according to claim 1, comprising:
determining a line progression of roadway lines in a traffic space around a vehicle while the vehicle is being driven by detecting the two-dimensional raster image of the raster cells in the capturing range in the traffic space around the vehicle by the optical sensor system arranged in the vehicle in the capturing range.

14. The method according to claim 2, comprising:
determining a line progression of roadway lines in a traffic space around a vehicle while the vehicle is being driven by detecting the two-dimensional raster image of the raster cells in the capturing range in the traffic space around the vehicle by the optical sensor system arranged in the vehicle in the capturing range.

15. The method according to claim 13, wherein a determination of a line probability of the roadway lines is performed based on the raster cells of the two-dimensional raster image in the capturing range in the traffic space around the vehicle.

16. A control module with at least one artificial neural network (ANN) and with the optical sensor system and/or a control unit and/or an evaluation unit to perform the method according to claim 1.
